(19) United States
(12) Patent Application Publication
(10) Pub. No.: US 2022/0156704 A1
(43) Pub. Date: May 19, 2022

(54) METHOD AND SYSTEM FOR TRANSMITTING DATA FROM MANUFACTURING DATA ORIGINATORS TO TARGET COMPUTING SYSTEMS USING DEFINED MESSAGE SCHEMAS

(71) Applicant: Ford Global Technologies, LLC, Dearborn, MI (US)

(72) Inventors: Paul Christopher Shaw, Amherstburg (CA); Geovanne Salvatore Taormina, JR., Monroe, MI (US)

(73) Assignee: Ford Global Technologies, LLC, Dearborn, MI (US)

(21) Appl. No.: 17/099,480

(22) Filed: Nov. 16, 2020

(51) Int. Cl. G06Q 10/00; G06Q 50/04; G07C 3/10; G07C 3/00; G07C 3/14; G06Q 10/06; G05B 19/4155; H04L 12/58

(52) U.S. Cl. CPC G06Q 10/20; G06Q 50/04; G07C 3/10; G07C 3/005; G05B 2219/31368; G06Q 10/06395; G05B 19/4155; H04L 51/18; G07C 3/146

(57) ABSTRACT

A method of transmitting data from a manufacturing data originator at a manufacturing facility to a target computing system includes acquiring data indicative of an operation of the manufacturing data originator and associating the data acquired to one or more fields among a plurality of fields of a predefined message schema for a designated message type among a plurality of message types. The method further includes populating values of the fields of the predefined message schema of the designated message type based on the data associated with the fields and on message control data, where the message control data includes a facility identification, a data originator identification, a schema version identifier, or a combination thereof. The method further includes generating a message data string based on the populated fields of the predefined message schema and transmitting the message data string to the target computing system.

### FIELD

The present disclosure relates to methods and/or systems for exchanging data between a manufacturing device and a computing system based on a data model.

### BACKGROUND

The statements in this section merely provide background information related to the present disclosure and may not constitute prior art.

Manufacturing processes generally encompass various types of devices/machines that can generate significant amount of data. For example, manufacturing facilities for assembling vehicles generate various types of data from automated robots issuing alerts to sensors performing quality check on the assembled vehicle. These data originators can include, but are not limited to: automated machine (robots, stamping press, computer numerical control (CNC) machines); sensors to measure various characteristics of the manufacturing process and even characteristics of the facility housing the processes; electronic tracking systems to track workpieces and/or assembled devices; and, electronic maintenance-health systems to schedule maintenance and/or health checks on various automated machines. Data from the various data originators can be employed by various users to not only monitor the operations within the facility, but to perform various analytics used to detect/predict possible faults and/or improve design of the vehicle and/or manufacturing process.

However, data from different data originators, which can include automated robots performing similar tasks, may use different naming conventions and/or terminologies, making it difficult to analyze data across multiple systems, let alone across multiple manufacturing facilities. These challenges with data utilization and other challenges are addressed by the present disclosure.

### SUMMARY

This section provides a general summary of the disclosure and is not a comprehensive disclosure of its full scope or all of its features.

In one form, the present disclosure is directed to a method of transmitting data from a manufacturing data originator at a manufacturing facility to a target computing system. The method includes acquiring, by a computing device associated with the manufacturing data originator, data indicative of an operation of the manufacturing data originator and associating, by the computing device, the data acquired to one or more fields among a plurality of fields of a predefined message schema for a designated message type among a plurality of message types. Each of the plurality of message types is associated with a respective predefined message schema. Each predefined message schema includes a header and a message body, the header and the message body include the plurality of fields that are configured as key-value pairs. The plurality of fields includes a plurality of required header fields to be employed for the header of all of the message schemas, where the required header fields are configured to identify the manufacturing data originator, identify the manufacturing facility, and identify the designated message type. The plurality of fields includes a plurality of message fields to be employed in the message body and are associated with the message type and the manufacturing data originator. The method further includes populating, by the computing device, values of the fields of the predefined message schema of the designated message type based on the data associated with the one or more fields and on message control data, where the message control data includes a facility identification, a data originator identification, a schema version identifier, or a combination thereof. The method further includes generating, by the computing device, a message data string based on the populated fields of the predefined message schema and transmitting, by the computing device, the message data string to the target computing system.

In one variation, the manufacturing data originator is an automation controller for a machine, a sensor, a maintenance system, a workpiece tracking system, an analytics controller, or a combination thereof.

In another variation, the manufacturing data originator is a automation controller for a machine and the plurality of message types includes at least one of the following messages for the machine: a machine state message to provide data regarding state, alerts, notifications, or a combination thereof of the machine; a machine configuration message to provide data regarding parameters of the machine that is adjustable by a user; a machine data message to provide data regarding cycle time, counts, events, variable time data, machine performance data, machine health data, or a combination thereof; a maintenance ticket message to request a maintenance ticket from the maintenance system, and a communication verification message to provide data regarding a transaction counter to inform the target computing system that the machine is communicating.

In yet another variation, the manufacturing data originator is a sensor and the plurality of message types includes at least one of the following messages for the sensor: a sensor data message to provide sensor measurement data and a sensor communication message to provide data regarding a transaction counter to inform the target computing system that the sensor is communicating.

In one variation, the manufacturing data originator is a workpiece tracking system that tracks a workpiece being processed within the facility and the plurality of message types includes a part data message for the workpiece tracking system, where the part data message provides a build status, an image data, a quality data associated with the part, or a combination thereof.

In another variation, the manufacturing data originator is a maintenance system and the plurality of message types includes at least one of the following messages for the maintenance system: a maintenance schedule message to schedule a time that the machine is to be off-line for maintenance-repair; and a maintenance instructions message to provide instructions of maintenance-repairs to be performed on the machine.

In yet another variation, the message fields include a primary field having one or more auxiliary fields related to the primary field.

In one variation, the message fields include at least one required field and at least one optional field, where the optional field is provided in the message data string when data associated with the key of the optional field is available.

In another variation, the at least one required field of the message fields includes a data source field to identify the data originator, a transaction counter field, a cycle identification field, or a combination thereof.

In yet another variation, to transmit the data string, the computing device employs message queuing telemetry transport (MQTT) with the target computing system.

In one variation, transmitting the data string further includes publishing a topic string to a MQTT broker, where the topic string is based on the header fields of the predefined message schema.

In another variation, the computing device is associated with a plurality of manufacturing data originators and is configured to generate and transmit data strings based on the predefined message schemas associated with the respective manufacturing data originators.

In yet another variation, the data acquired is untethered data that is un-associated with contextual information, and the data is associated with the one or more fields further based on a predefined correlation of the untethered data with a respective field among the one or more fields.

In one variation, the plurality of fields includes at least one optional header field to be employed in the header by at least one predefined message schema.

In one form, the present disclosure is directed toward a system for transmitting data from a manufacturing data originator at a manufacturing facility to a target computing system. The system includes a computing device configured to store a predefined message schema for a designated message type from among a plurality of message types. Each of the plurality of message types is associated with a respective predefined message schema. Each predefined message schema includes a header and a message body, the header and the message body include a plurality of fields that are configured as key-value pairs. The plurality of fields includes a plurality of required header fields to be employed for the header of all of predefined message schemas, the required header fields are configured to identify the manufacturing data originator, identify the manufacturing facility, and identify the designated message type. The plurality of fields includes a plurality of message fields to be employed in the message body and are associated with the message type and the manufacturing data originator. The computing device is further configured to acquire data indicative of an operation of the manufacturing data originator, associate the data acquired to one or more fields among the plurality of fields of the predefined message schema for the designated message type and populate values of the plurality of fields of the predefined message schema of the designated message type based on the data associated with the one or more fields and on message control data, where the message control data includes a facility identification, a data originator identification, a schema version identifier, or a combination thereof. The computing device is further configured to generate a message data string based on the populated fields of the predefined message schema and transmit a message payload indicative of the message data string to the target computing system.

In one variation, the computing device stores predefined message schemas for at least two message types from among the plurality of message types, where the at least two message types are selected from among the following: a machine state message to provide data regarding state, alerts, notifications, or a combination thereof of a machine; a machine configuration message to provide data regarding parameters of the machine that is adjustable by a user; a machine data message to provide data regarding cycle time, counts, events, variable time data, machine performance data, machine health data, or a combination thereof; a maintenance ticket message to request a maintenance ticket for the machine; a communication verification message to provide data regarding a transaction counter to inform the subscribed computing system that the manufacturing data originator is communicating; a sensor data message to provide sensor measurement data; a part data message to provide build status, image data, quality data associated with the part, or a combination thereof; a maintenance schedule message to schedule a time that the machine is to be off-line for maintenance-repair; and a maintenance instructions message to provide instructions of maintenance-repairs to be performed on the machine.

In another variation, the message fields include at least one required field and at least one optional field, where the optional field is provided in the message data string when data associated with the key of the optional field is available.

In yet another variation, the at least one required field of the message fields includes a data source field to identify the data originator, a transaction counter field, a cycle identification field, or a combination thereof.

In one form, the present disclosure is directed toward a method of transmitting data from a manufacturing data originator at a manufacturing facility to a target computing system. The method includes defining a plurality of message schemas for a plurality of message types. Each of the message schemas includes a header and a message body, the header and the message body include a plurality of fields that are configured as key-value pairs. The plurality of fields includes a plurality of required header fields to be employed for the header of all of the plurality of message schemas, the required header fields are configured to identify the manufacturing data originator, identify the manufacturing facility, and identify the designated message type. The plurality of fields includes a plurality of message fields to be employed in the message body and are associated with the message type and the manufacturing data originator. The method further includes acquiring, by a computing device associated with the manufacturing data originator, data indicative of an operation of the manufacturing data originator, associating, by the computing device, the data acquired to one or more fields among the plurality of fields of a defined message schema for a designated message type among the plurality of message types based on the keys of the one or more fields, and populating, by the computing device, values of the one or more fields of the defined message schema based on the data associated with the one or more fields and message control data, where the message control data includes a facility identification, a data originator identification, a cycle identification, a schema version identifier, or a combination thereof. The method further includes generating, by the computing device, a message data string based on the populated fields of the defined message schema for the designated message type and transmitting, by the computing device, the message data string to the target computing system by way a message queuing telemetry transport (MQTT) broker.

In one variation, the message fields include at least one required field and at least one optional field, where the optional field is provided in the message data string when data associated with the key of the optional field is available, and the at least one required field of the message fields includes a data source field to identify the data originator, a transaction counter field, a cycle identification field, or a combination thereof.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a block diagram of a system having a message generation module for transmitting messages employing predefined message schemas in accordance with the present disclosure;

FIG. 2 is a block diagram of asset hierarchy of a manufacturing enterprise in accordance with the present disclosure;

FIG. 3 is an exemplary message schema for a machine state message in accordance with the present disclosure; and

FIG. 4 is a block diagram of the message generation module of FIG. 1.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

A manufacturing facility for producing an assembled device such as but not limited to: a fully-assembled vehicle, a powertrain system, vehicle body, and/or climate control system, generally includes multiple data generating systems/devices. For example, data can be generated by: machining system having a controller (e.g., a programmable logic controller (PLC)), robotic systems; sensors disposed at various machining systems for monitoring the machine and/or disposed throughout the facility for monitoring production of the assembled device; a test system for evaluating performance and quality of the assembled device; and/or an inventory system for tracking the assembled device and/or parts used for the assembled device. While specific example of data generating systems/devices are provided it should be readily understood that other data generating systems/device may be provided and the present disclosure should not be limited to the examples described herein.

The present disclosure provides a uniform-adaptable data model for defining message schemas for various types of messages to be employed for transmitting data generated by a data originator. In one form, the each of the message schemas include a header and a message body, both having a plurality of fields. The fields are provided as key-value pairs in which the key provides information regarding the value associated with the key. The header for each message schema includes required header fields used to identify the data originator, the manufacturing facility, among other information. The message body is generally customizable based on the data originator. In addition, while the defined message schema may include multiple fields, the data model only employs the fields needed to transmit the acquired data. That is, if data is unavailable for a respective field, that field is not included in the message body during transamidation of the message. As such, the data model is designed such that all desired data can be fit into the fields that are defined with the intent to only use the portions of the defined message schemas that may be required at any point in time, allowing the size of the data message to vary real-time. This provides flexible customization of messages being transmitted while still adhering to a standard model. It should be readily understood that the method and/or system the present disclosure addresses other issues and should not be limited to the examples provided herein.

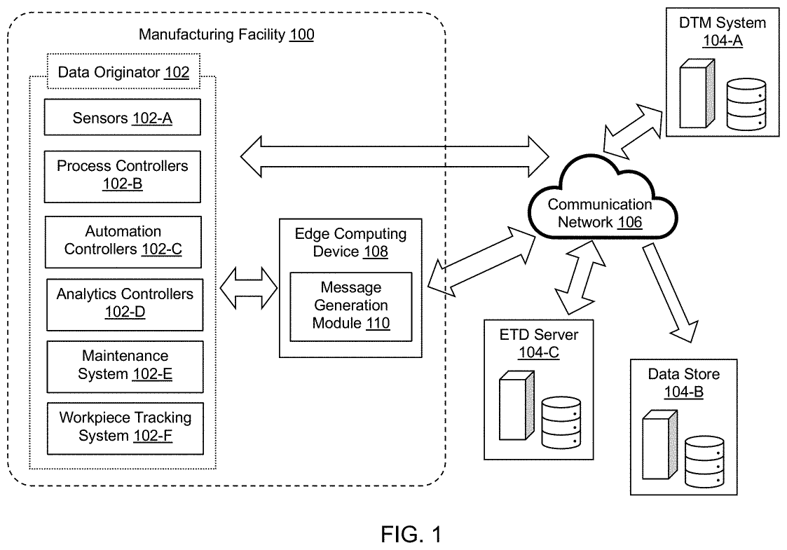

Referring to FIG. 1, a manufacturing facility 100 typically includes multiple manufacturing data originators 102 (i.e., “data originators 102”) that include, but are not limited to sensors 102-A, process controllers 102-B, automation controllers 102-C, analytics controllers 102-D, a maintenance system 102-E, and a workpiece tracking system 102-F. In one form, sensors 102-A include, but are not limited to: equipment sensors disposed at machine such as CNC machines, robotic systems, stamping press, among others to monitor the performance characteristics of the machine (e.g., torque, vibration, temperature, position, force, among other characteristics based on the equipment); part monitoring sensors (e.g., cameras, temperature sensors, etc.) at individual cells to monitor workpieces being formed at the cell; and/or infrastructure sensors (e.g., temperature sensors, cameras, motion sensors, etc.) disposed throughout the facility for monitoring operations within the facility. In one form, the sensors 102 generate data related to, but not limited to measurements taken by a sensory component of the sensor (e.g., images, temperature measurement, acceleration, etc.), and/or sensor communication data indicating the sensor is operating/communicating, among other data.

In one form, process controllers 102-B are configured to monitor manufacturing operations from machining or stamping to performing a visual inspection of workpieces and/or the process being performed. For example, process controllers 102-B include, but are not limited to: an end-of-line test controller for conducting one or more tests on the assembled device; a vision inspection controller configured to analyze data from imaging sensors (e.g., multi-dimensional cameras/scanners) to monitor assembly of a workpiece/assembled device and/or to detect abnormalities in the workpiece/assembled device; and/or a tooling controller for a given tool used by an operator to analyze data from the tool and determine if the tool was used correctly.

In one form, the automation controllers 102-C are configured to operate machines such as robotic systems, CNC machining equipment, stamping press, and/or molding machines, among other machines. The automation controllers 102-C may generate significate amount of data related to, but not limited to: machine state data regarding state (eq., idle, active, etc., off-line), alerts, and/or notifications; machine configuration data regarding parameters/settings of the machine that are adjustable by a user; equipment operation data regarding cycle time, counts, events, variable time data, performance data, health data; maintenance ticket data to request a maintenance ticket from the maintenance system 102-E; and/or communication verification data indicating that the automation controller is active/communication, as described herein.

In one form, the analytics controller 102-D is configured to perform one or more types of data analytics based on data from other data originators to determine, for example, trends in workpiece quality, performance of machine, processing delays, among other information. Data from the analytics controller 102-D can be employed to, for example, calibrate sensors 102-A and/or machines, issue notifications for maintenance-repair and/or quality concerns, and/or adjust manufacturing processes, among other actions.

In one form, the maintenance system 102-E is configured to track performance/health of one or more machines within the facility and schedule a maintenance-repair of the machine. The maintenance system 102-E may include, but is not limited to: a dedicated server providing information regarding maintenance of the machines within the facility; a preventative maintenance controller configured to analyze data from one or more machines to determine whether a maintenance-repair is to be scheduled for the machine; and/or other controllers configured to monitor the health and schedule maintenance of a machine. The data provided by the maintenance system 102-E includes, for example, a maintenance schedule providing a time that a machine is to be off-line for a designated maintenance-repair task, instructions for performing a maintenance-repair on the machine, and/or status of a maintenance-repair check, among other information.

In one form, the workpiece tracking system 102-F tracks a workpiece being processed within the facility and includes, but is not limited to: a designated server for providing information regarding workpieces being transformed in the facility for the assembled device; a part verification controller for verifying a workpiece identification, which can be disposed throughout the facility even at a machine, and/or other controllers/devices configured to identify and/or verify the workpiece (e.g., a computing device of the machines may have the information regarding the workpiece and thus, be a workpiece tracking system). The data provided by the workpiece tracking system 102-F includes, but is noted limited to: build status, image data, and/or quality data associated with the workpiece.

In one form, the various data originators 102 can be communicably coupled to other data originators 102 via wired/wireless communication networks. For examples, a sensor 102-A at a machine transmits data to the automation controller 102-C associated with the machine to monitor performance of the operation being performed by the machine. While specific examples of data originators 102 are provided, the manufacturing facility 100 may include other data originators 102 and should not be limited to the examples provided herein.

Data from data originators 102 may be transmitted to a target computing system for further analysis and/or storage by way of a communication network 106. For example, the target computing system may include a digital twin manufacturing (DTM) system 104-A, a data store 104-B configured to organize and store the data, and/or an engineering tool data (ETD) server 104-C configured to organize, aggregate, and store the data which can be selected by a user via a user interface and analyzed using defined software programs. The DTM system 104-A, the data store 104-B, and the ETD server 104-C are collectively referred to as target computing system 104. The target computing system 104 may be provided within the manufacturing facility and/or at a different location. In addition, the target computing system 104 may include other types of analytical systems and should not be limited to the examples provided herein.

In one form, a data originator 102 may be configured to process the generated data based on a predefined message schema and directly transmit a message payload to the communication network 106 via wired/wireless communication link. In another form, a data originator 102 transmits data to an edge computing device 108 configured to process the received data as it is being received based on a predefined message schema and transmit the data to the communication network 106 employing the selected wireless protocol. For example, a first sensor 102-A may include a computing device configured to process its data based on the message schema and directly transmit a message payload to the communication network 106, whereas another sensor 102-A may transmit measurement data to the edge computing device 108 for further processing and transmission. In one variation, the manufacturing facility may include one or more edge computing devices that are configured to process data from one or more designated data originators 102.

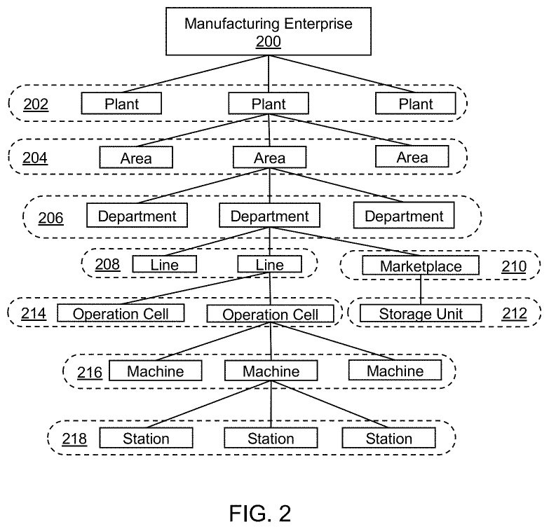

As demonstrated above, a single manufacturing facility 100 includes multiple data originators 102 and each data originator 102 provides different type of data that can be provided in different formats. With reference to FIG. 2, in an exemplary application, a manufacturing enterprise 200 is organized to include multiple plants 202 (i.e., manufacturing facilities). Each plant 202 includes multiple areas 204 that further include multiple departments 206. Each department 206 may then include multiple production lines 208 and/or marketplace 210 housing components/parts/workpieces in storage units 212. Each line 208 includes operations cells 214 which further includes multiple machines 216 that are associated with multiple stations 218. From the station 218 to the area 204, each plant 202 can include one or more data originators 102 of FIG. 1, thereby adding an additional lay of complexity with regard to storing and employing the data for additional analysis.

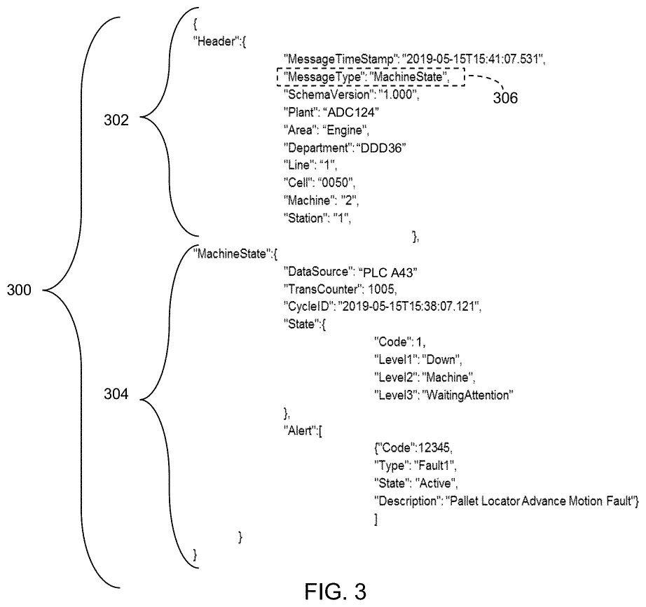

With continuing reference to FIG. 1, in one form, the present disclosure provides for a message generation module 110 configured to transmit messages using one or more predefined message schemas comprising a plurality of fields. More particularly, each type of data originator 102 is associated with one or more message types, where each message type is associated with a predefined message schema having a header and a message body. Each field is provided in a key:value format and the plurality of fields include a combination of required fields and optional fields. For example, with reference to FIG. 3, an example of a machine state message 300 having a header 302 and a message body 304 is provided. As described herein, the header 302 and message body 304 include multiple fields, where each field includes a key followed by a value associated with the key. For instance, the header includes a field 306 having a key as “MessageType” and a corresponding value of “MachineState”. In one exemplary application, the predefined message schema is based on JavaScript Object Notation (JSON) messages using key:value pairs, which provides all data is reported with a label to give it meaning. While the message generation module 110 is provided as part of the edge computing device 108, it may also be employed by a data originator 102 having a computing device to transmit a message directly to the communication network 106.

In one form, a uniform adaptable data model is employed to define the predefined message schemas for the various message types. In one form, the uniform adaptable data model defines, for each field, a data type (e.g., manufacturing facility identification (ID), timestamp, area within manufacturing facility, machine identification, station, etc.), a limitation (e.g., max number of characters), and requirement (e.g., optional field, required filed, “null” option if required field). The data model is configured such that all desired data can be fit into the fields that are defined with the intent to only use the portions of the schemas that may be required at any point in time, allowing the size of the message to adjust based on data availability.

In one form, the header is defined based on a hierarchy of the manufacturing enterprise such as the one provided in FIG. 2. More particularly, the header provides information regarding the message schema being employed, the location of the manufacturing data originator, information to identify the manufacturing facility, and/or identify the type of message provided in the message body (i.e., message type). In one application, information provided in the header is employed by the target computing system 104 in storing the data in the message body. In one form, the header includes a plurality of header fields selected from among predefined header fields that are to be employed with message schemas. In one application, the predefined header fields include required header fields to be used with all message schemas and optional header fields. For example, the header fields include, but are not limited to, a timestamp field, a schema version field to identify the version the message is based on, a message type field, and/or one or more data originator identification (ID) field. In one form, the data originator identification field(s) includes, but is not limited to, the field provided in table 1 below.

TABLE 1
Example Data Originator ID Field
Data Originator ID Fields
Plant (i.e., manufacturing facility) ID Field: identifies the
manufacturing facility that the message is being transmitted from
Area ID Field: Identifies the area within the plant that the data is from
Department ID Field: identifies the department within the plant
associate with the data
Line ID Field: identifies a sequence of operations or cells
Cell ID Field: identifies a cell or operation within the line
Machine ID Field: identifies a subset of the cell when the cell consists
of multiple like machines
Station ID Field: identifies a pitch and/or position of an asset/machine
type within an operation

From among the examples of predefined header fields, one or more fields are provided as required header fields (e.g., the timestamp field, the schema version field, the message type field, at least one data originator ID field such as plant ID) and the other fields may be provided as optional fields (e.g., cell ID field, and/or machine ID field). In one form, each header field is associated with a character limitation, a format (e.g., string of numbers only, string of number and/or letters, time, etc.), whether the field is required to have a value, and/or whether the value of the field can be “null.” In one form, possible values for the data originator fields are selected from standardized list employed throughout the manufacturing enterprise.

The message body includes a plurality of message fields selected from among predefined message fields for designated data originator(s) 102. Each message type includes message fields in the message body that are associated with the manufacturing data originator 102. As such, the message body for a given message type can be customizable to include message fields associated with data originator 102. In addition, the message body may define a specific nesting structure in which a primary message field is associated with one or more auxiliary message fields related to the primary field to convey additional information when needed. In one form, the message body is configured to include one or more required message fields such as one or more message fields provided in table 2 below.

TABLE 2
Example Message Fields
Message Fields
Data Source Field: identifies the data originator
Transaction Counter Field: provides the number of times the message is
transmitted based on a counter that is incremented each time the
message is sent, where the counter is controlled by the computing device
having the message generation module
Cycle ID Field: employed to link different messages that happen during
the same cycle and/or before the next cycle

In an exemplary application, example message types are provided in table 3 below for the sensors 102-A, the automation controller 102-C (i.e., machines), the maintenance system 102-E, and the workpiece tracking system 102-F. While specific message types are provided, the selected data originators may include other message types. In addition, message types having predefined message schemas based on the present disclosures may be provided for different data originators, such as but not limited to the process controller 102-B and/or the analytics controller 102-D.

TABLE 3
Example Message Types

| Data | |
|---|---|
| Originator | Message Type |
| Machine/ | Machine State Message: provides data regarding state, |
| Automation | alerts, notifications, or a combination thereof of |
| Controllers | the machine |
| | Machine Configuration Message: provides data regarding |
| | parameters of the machine that is adjustable by a user |
| | Machine Data Message: provides data |
| | regarding cycle time, counts, events, |
| | variable time data, machine performance |
| | data, machine health data, or a combination thereof |
| | Maintenance Ticket Message: request a maintenance |
| | ticket from the maintenance system |
| | Communication Verification Message: provides data |
| | regarding a transaction counter to inform the target |
| | computing system that the machine is communicating |
| Sensor | Sensor Data Message: Provides sensor measurement data |
| | Sensor Communication Message: provides data regarding |
| | a transaction counter to inform the subscribed computing |
| | system that the sensor is communicating |
| Workpiece | Part Data Message: provides build status, image data, |
| Tracking | quality data associated with the part, or a combination |
| System | thereof |
| Maintenance | Maintenance Schedule Message: schedules a time that |
| System | the machine is to be off-line for maintenance-repair |
| | Maintenance Instructions Message: provides instructions |
| | of maintenance-repairs to be performed on the machine |
| Other | Data Source Registration Message: provides identification |
| message | of a new data originator to an asset directory tracking |
| Types | various machines/sensors |

For each message type, the message body is customizable to convey the appropriate information for that message. In one form, the uniform adaptable data model provides a library of defined fields available for a given message type, where some fields include a primary field(s) that include additional auxiliary fields for capturing the information of the primary field. For example, table 4 below illustrates example message fields available for machine state message. In this example, primary fields having auxiliary fields includes state field, an alert field, and a notification field. Like the header fields, the data model defines parameters for each message field such as whether the field is required, the number of characters, the type of data to be inputted (e.g., numerical value associated with a specific alert), among other parameters. Optional message fields, as the name suggests, are only employed when needed. For example, if there are no alerts or notification to report, such fields are not employed when the machine state message is generated, but if an alert is issued, the alert field will be used to provide information to the user. A similar set of defined message fields is provided for each message type.

TABLE 4
Example of Available Message Fields For A Machine State Message

| | Auxiliary Field (if | |
|---|---|---|
| Fields | available) | Description |
| DataSource | | Name of the Device that is reporting |
| | | the data |
| TransCounter | | Data from transaction counter that |
| | | increments the counter after sending |
| | | message (value 1-9999) |
| CycleID | | Timestamp of the start of cycle. E.g., |
| | | format 2019-12-31E5T23:59:59.999 |
| State | Code | Numeric value assigned to current |
| | | state of machine. Codes are predefined |
| | Level1 | High level machine state Up or Down |
| | Level2 | Moderate level machine state |
| | Level3 | Fine detail level of machine state |
| AuxMode | | Auxiliary mode of a machine (e.g., |
| | | runout, capability, or energy |
| | | conservation) |
| Alert(1 . . . n) | Code | Unique fault or warning code, where |
| | | alert codes are predefined |
| | Type | Alert type, which is selected from |
| | | predefined alert types. |
| | State | Alert state |
| | Subsystem | Subsystem within the asset used to |
| | | subdivide the asset into groups of |
| | | devices |
| | Device | Physical Device associated to the alert |
| | | such as an actuator or switch |
| | Action | Device Action when alert happened |
| | Failure | Failure mode of the device |
| | Description | Fault description text, For legacy |
| | | systems where the |
| | | Device/Action/Failure resolution is not |
| | | programmed |
| | PossibleCause | Possible cause of the alert |
| | PotCorrAction | Potential corrective action for the alert |
| | DeviceDiagCode | Diagnostic code |
| | DeviceDiagDesc | Diagnostic description |
| | ResultValue | Value associated to the cause of alert |
| | | when a measured or calculated value |
| | | is associated to the alert |
| | Units | Units associated to the value |
| | UpperLimit | Upper threshold of the value |
| | LowerLimit | Lower threshold of the value |
| Notification | AssistanceReqd | Person or group requested for |
| (1 . . . n) | | assistance |
| | Page | Text to page |
| | Push | Text to push |
| | Andon | Text to display on Andon board |
| Controller | | Controller warning |
| MessageError | Label | Error Label |
| (1 . . . n) | Path | Indication of where in the message |
| | | payload the error occurred |
| | Description | Description of the error |

In one form, the available message fields for a message type are based on the data generated by the data originators and what the data is intended for. For example, an analytics controller 102-D is configured to issue weekly quality reports for a workpiece formed by a CNC machine based on data from a sensor 102-A (e.g., cameras). One possible message type to be transmitted is “WeeklyQualityMessage”, the message fields are configured to capture the number of workpieces generated, the time period (e.g., start time, end time) of the weekly assessment, whether defected workpieces were detected, and if so, the number of defected workpieces. The keys of the message fields are configured to identify the values associated with the key (e.g., “Start” to indicate state date-time of weekly assessment and “End” to indicate end date-time of weekly assessment). While the message fields are customizable, in one application, the naming convention and defined parameters of the fields is kept broad, so as to be used across different analytics controllers. In one form, once the message types are defined, they are employed throughout the manufacturing enterprise.

With the predefined message schema(s) stored therein for the message type(s) to be transmitted, the message generation module 110 is configured to construct a message data string and transmit the message data string to the target computing system(s) 104 via the communication network 106. In one form, the message generation module 110, the communication network 106, and the target computing systems 104 employ machine-to-machine communication protocol such as message queuing telemetry transport (MQTT). Other protocols may also be used such as, but not limited to: Open Platform Communications (OPC) Unified Architecture (UA), OPC Data Access (DA), Advanced Message Queuing Protocol (AMQP), among others. Accordingly, requisite hardware and/or software components (e.g., routers, transceivers, servers, processors, software protocols, etc.) can be provided for supporting the machine-to-machine communication protocol being used. For example, the manufacturing facility may include a MQTT broker (i.e., server) that routes messages from, for example, the message generation module 110 to one or more target computing systems 104 that have subscribed to the information. While the present disclosure discusses messages being transmitted to the target computing systems 104, it should be readily understood that the target computing systems 104 may send messages to the data originators via the MQTT broker.

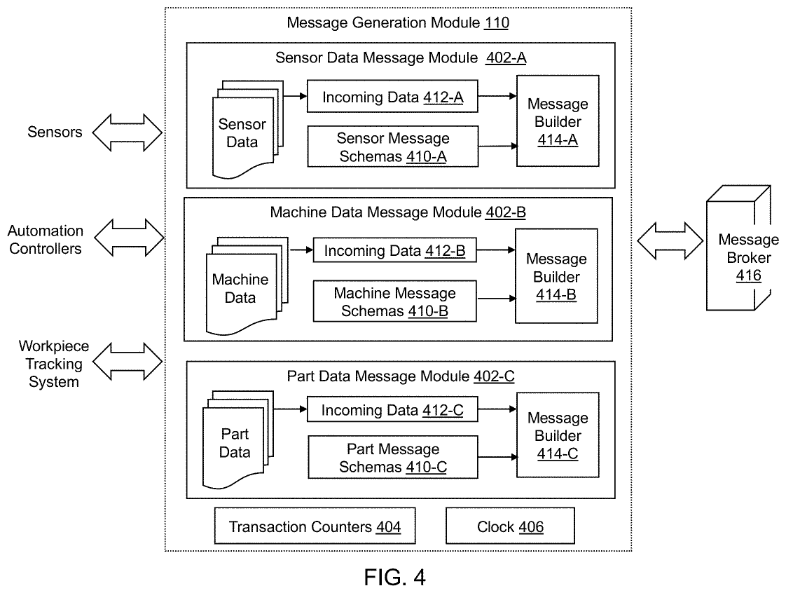

With reference to FIG. 4, an exemplary block diagram of the message generation module 110 is provided. The message generation module 110 is configured to generate message data strings using predefined message schemas for various message types. More particularly, in this example, the message generation module 110 receives data from sensor 102-A, automation controller 102-C, and workpiece tracking system 102-F to generate messages using message types associated with the respective data originator. According, here the message generation module 110 is configured to includes a sensor data message module 402-A, a machine data message module 402-B, and a part data message module 402-C (collectively “data message modules 402”). In one form, the message generation module 110 further includes transaction counters 404 for independently tracking communication with each of the data originators associated with the module 110 and an internal clock 406 for providing time data. In another form, the message generation module 110 may utilize a counter and/or clock of the computing device having the message generation module 110.

Each of the data message modules 402 stores the predefined message schemas for the message types associated with the respective data originators. Specifically, here, the sensor data message module 402-A includes sensor message schemas 410-A, the machine data message module 402-B includes machine message schemas 410-B, and the part data message module 402-C includes part message schemas 410-C. The sensor message schemas 410-A, the machine message schemas 410-B, and the part data message module 410-C are collectively referred to as “message schemas 410” and store message schemes for message types provided in table 3 for the respective data originators 102.

In operation, each message module 402 is configured to acquire data indicative of an operation of the data originator 102, which is represented by incoming data block 412 (block 412-A, 412-B, and 412-C in FIG. 4). In one form, the data acquired is untethered data in that it is raw data (e.g., numerical codes for alerts, numerical controls of a PLC, alpha-numeric data strings, etc.) that is unassociated with contextual data indicating what the data is.

The message builder 414 (i.e., builders 414-A, 414-B, and 414-C in FIG. 4) is configured to associate the data acquired to one or more fields among the plurality of fields of a selected message type based on the key of the fields. In one form, a predefined correlation is provided to correlate specific data types to a respective field.

The message builder 414 is further configured to populate the values of the fields based on the data associated with the one or more fields and on message control data. In one form, the message control data is maintained by the message generation module 110 and includes a facility identification, a data originator identification, a cycle identification, a schema version identifier, or a combination thereof. Once populated, the message builder 414 is configured to generate a message data string based on the populated fields of the predefined message schema, where the message data string includes the key:value pairs of the one or more fields. The message builder 414 further transmits the message data string (i.e., a message payload) to the target computing system 104 by way the communication network 106. More particularly, in one application, the message builder 414 transmits the message data string to a message broker 416 (e.g., MQTT broker), which forwards a message payload indicative of the message data string to subscribers of the message (i.e., a target computing system 104.) For instance, the message builder 414 is configured to publish a topic string to the message broker 416, where the topic string is based on the header fields of the predefined message schema.

While the message generation module 110 of FIG. 4 is illustrated to having three data message modules, the message generation module 110 may include one or more data message modules based on the data originator 102 providing data to the message generation module 110. For example, if a sensor is configured as a smart device having a computing system with an independent communication module in communication with message broker, the sensor may include a message generation module only having a sensor data message module. In another example, an edge device having the message generation module may receive data from multiple automation controllers (e.g., PLCs of multiple machine), and thus. include one or more machine data message modules for transmitting machine type messages.

In one form, the target computing system 104 is configured to process the messages to determine if the messages are valid and if so, store the data within the message body based on the data in the header. Specifically, to authenticate the message, the target computing system 104, verifies the format of the received message based on the version of the schema provided in the header of the message. If the format of the received message does not match that of the predefined message schema associated with the version, the data is not saved. If the format does match, data is parsed and stored using the information in the header which provides information regarding the source of the data within the message body. In one form, the data within the header itself may not be stored.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

In the figures, the direction of an arrow, as indicated by the arrowhead, generally demonstrates the flow of information (such as data or instructions) that is of interest to the illustration. For example, when element A and element B exchange a variety of information, but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

What is claimed is:

1. A method of transmitting data from a manufacturing data originator at a manufacturing facility to a target computing system, the method comprising:
acquiring, by a computing device associated with the manufacturing data originator, data indicative of an operation of the manufacturing data originator;
associating, by the computing device, the data acquired to one or more fields among a plurality of fields of a predefined message schema for a designated message type among a plurality of message types, wherein:
each of the plurality of message types is associated with a respective predefined message schema;
each predefined message schema includes a header and a message body, the header and the message body include the plurality of fields that are configured as key-value pairs,
the plurality of fields includes a plurality of required header fields to be employed for the header of all of the predefined message schemas, the required header fields are configured to identify the manufacturing data originator, identify the manufacturing facility, and identify the designated message type, and
the plurality of fields includes a plurality of message fields to be employed in the message body and are associated with the message type and the manufacturing data originator;
populating, by the computing device, values of the fields of the predefined message schema of the designated message type based on the data associated with the one or more fields and on message control data, wherein the message control data includes a facility identification, a data originator identification, a schema version identifier, or a combination thereof;
generating, by the computing device, a message data string based on the populated fields of the predefined message schema; and
transmitting, by the computing device, the message data string to the target computing system.

2. The method of claim 1, wherein the manufacturing data originator is an automation controller for a machine, a sensor, a maintenance system, a workpiece tracking system, an analytics controller, or a combination thereof.

3. The method of claim 2, wherein the manufacturing data originator is an automation controller for a machine and the plurality of message types includes at least one of the following messages for the machine:
a machine state message to provide data regarding state, alerts, notifications, or a combination thereof of the machine,
a machine configuration message to provide data regarding parameters of the machine that is adjustable by a user,
a machine data message to provide data regarding cycle time, counts, events, variable time data, machine performance data, machine health data, or a combination thereof,
a maintenance ticket message to request a maintenance ticket from the maintenance system, and
a communication verification message to provide data regarding a transaction counter to inform the target computing system that the machine is communicating.

4. The method of claim 2, wherein the manufacturing data originator is a sensor and the plurality of message types includes at least one of the following messages for the sensor:
a sensor data message to provide sensor measurement data, and
a sensor communication message to provide data regarding a transaction counter to inform the target computing system that the sensor is communicating.

5. The method of claim 2, wherein the manufacturing data originator is a workpiece tracking system that tracks a workpiece being processed within the facility and the plurality of message types includes a part data message for the workpiece tracking system, wherein the part data message provides a build status, an image data, a quality data associated with the part, or a combination thereof.

6. The method of claim 2, wherein the manufacturing data originator is a maintenance system and the plurality of message types includes at least one of the following messages for the maintenance system:
a maintenance schedule message to schedule a time that a machine is to be off-line for maintenance-repair, and
a maintenance instructions message to provide instructions of maintenance-repairs to be performed on the machine.

7. The method of claim 1, wherein the message fields include a primary field having one or more auxiliary fields related to the primary field.

8. The method of claim 1, wherein the message fields include at least one required field and at least one optional field, wherein the optional field is provided in the message data string when data associated with the key of the optional field is available.

9. The method of claim 8, wherein the at least one required field of the message fields includes a data source field to identify the data originator, a transaction counter field, a cycle identification field, or a combination thereof.

10. The method of claim 1, wherein to transmit the data string, the computing device employs message queuing telemetry transport (MQTT) with the target computing system.

11. The method of claim 10, wherein transmitting the data string further comprises publishing a topic string to a MQTT broker, wherein the topic string is based on the header fields of the predefined message schema.

12. The method of claim 1, wherein the computing device is associated with a plurality of manufacturing data originators and is configured to generate and transmit data strings based on the predefined message schemas associated with the respective manufacturing data originators.

13. The method of claim 1, wherein the data acquired is untethered data that is unassociated with contextual information, and the data is associated with the one or more fields further based on a predefined correlation of the untethered data with a respective field among the one or more fields.

14. The method of claim 1, wherein the plurality of fields includes at least one optional header field to be employed in the header by at least one predefined message schema.

15. A system for transmitting data from a manufacturing data originator at a manufacturing facility to a target computing system, the system comprising:
a computing device configured to:
store a predefined message schema for a designated message type from among a plurality of message types, wherein:
each of the plurality of message types is associated with a respective predefined message schema,
each predefined message schema includes a header and a message body, the header and the message body include a plurality of fields that are configured as key-value pairs,
the plurality of fields includes a plurality of required header fields to be employed for the header of all of the predefined message schemas, the required header fields are configured to identify the manufacturing data originator, identify the manufacturing facility, and identify the designated message type, and
the plurality of fields includes a plurality of message fields to be employed in the message body and are associated with the message type and the manufacturing data originator;
acquire data indicative of an operation of the manufacturing data originator;
associate the data acquired to one or more fields among the plurality of fields of the predefined message schema for the designated message type;
populate values of the plurality of fields of the predefined message schema of the designated message type based on the data associated with the one or more fields and on message control data, wherein the message control data includes a facility identification, a data originator identification, a schema version identifier, or a combination thereof;
generate a message data string based on the populated fields of the predefined message schema; and
transmit a message payload indicative of the message data string to the target computing system.

16. The system of claim 15, wherein the computing device stores predefined message schemas for at least two message types from among the plurality of message types, wherein the at least two message types are selected from among the following:
a machine state message to provide data regarding state, alerts, notifications, or a combination thereof of a machine,
a machine configuration message to provide data regarding parameters of the machine that is adjustable by a user,
a machine data message to provide data regarding cycle time, counts, events, variable time data, machine performance data, machine health data, or a combination thereof,
a maintenance ticket message to request a maintenance ticket for the machine,
a communication verification message to provide data regarding a transaction counter to inform the subscribed computing system that the manufacturing data originator is communicating,
a sensor data message to provide sensor measurement data,
a part data message to provide build status, image data, quality data associated with the part, or a combination thereof,
a maintenance schedule message to schedule a time that the machine is to be off-line for maintenance-repair, and
a maintenance instructions message to provide instructions of maintenance-repairs to be performed on the machine.

17. The system of claim 15, wherein the message fields include at least one required field and at least one optional field, wherein the optional field is provided in the message data string when data associated with a key of the optional field is available.

18. The system of claim 17, wherein the at least one required field of the message fields includes a data source field to identify the data originator, a transaction counter field, a cycle identification field, or a combination thereof.

19. A method of transmitting data from a manufacturing data originator at a manufacturing facility to a target computing system, the method comprising:
defining a plurality of message schemas for a plurality of message types, wherein:
each of the message schemas includes a header and a message body, the header and the message body include a plurality of fields that are configured as key-value pairs,
the plurality of fields includes a plurality of required header fields to be employed for the header of all of the plurality of message schemas, the required header fields are configured to identify the manufacturing data originator, identify the manufacturing facility, and identify the designated message type, and
the plurality of fields includes a plurality of message fields to be employed in the message body and are associated with the message type and the manufacturing data originator;
acquiring, by a computing device associated with the manufacturing data originator, data indicative of an operation of the manufacturing data originator;
associating, by the computing device, the data acquired to one or more fields among the plurality of fields of a defined message schema for a designated message type among the plurality of message types based on the keys of the one or more fields;
populating, by the computing device, values of the one or more fields of the defined message schema based on the data associated with the one or more fields and message control data, wherein the message control data includes a facility identification, a data originator identification, a cycle identification, a schema version identifier, or a combination thereof;
generating, by the computing device, a message data string based on the populated fields of the defined message schema for the designated message type; and
transmitting, by the computing device, the message data string to the target computing system by way a message queuing telemetry transport (MQTT) broker.

20. The method of claim 19, wherein:
the message fields include at least one required field and at least one optional field, wherein the optional field is provided in the message data string when data associated with the key of the optional field is available, and
the at least one required field of the message fields includes a data source field to identify the data originator, a transaction counter field, a cycle identification field, or a combination thereof.
